(19) United States
(12) Patent Application Publication
(10) Pub. No.: US 2014/0307091 A1
(43) Pub. Date: Oct. 16, 2014

(54) IMAGE DISPLAY METHOD AND IMAGE DISPLAY SYSTEM

(71) Applicants: Yuan-Shie Chang, Taipei City (TW); Chia-Hung Ou, Taipei City (TW); Chia-Chi Ou, Taipei City (TW)

(72) Inventors: Yuan-Shie Chang, Taipei City (TW); Chia-Hung Ou, Taipei City (TW); Chia-Chi Ou, Taipei City (TW)

(73) Assignee: COMPAL ELECTRONICS, INC., Taipei City (TW)

(21) Appl. No.: 13/900,541

(22) Filed: May 23, 2013

(30) Foreign Application Priority Data
Apr. 11, 2013 (TW) 102112865

(51) Int. Cl. H04N 7/18

(52) U.S. Cl. CPC H04N 7/183
USPC 348/148

(57) ABSTRACT

An image display method and an image display system are provided. The image display system is deployed in a vehicle. An external image outside the vehicle is captured through a first image capturing unit, and a specific range image is selected in the external image according to an adjusting signal. The specific range image is displayed in a display unit disposed on a pillar inside the vehicle.

### CROSS-REFERENCE TO RELATED APPLICATION

This application claims the priority benefit of Taiwan application serial no. 102112865, filed on Apr. 11, 2013. The entirety of the above-mentioned patent application is hereby incorporated by reference herein and made a part of this specification.

### BACKGROUND OF THE INVENTION

1. Field of the Invention

The present invention generally relates to an image processing system, and more particularly, to an image display method and an image display system applicable to a vehicle.

2. Description of Related Art

The pillars in a vehicle are usually used for enhancing the structural strength of the vehicle. Besides the supporting function, the pillars are also served as doorframes. Generally, there are three groups of pillars in a vehicle (i.e., the front pillars located at both sides of the front windshield, the middle pillars located between the front doors and the back doors, and the rear pillars located at both sides of the rear windshield).

Among all the pillars, the front pillars affect the driver the most. The view blocking effect brought by the front pillars to the driver has to be taken into consideration when the front pillars are designed. Namely, the front pillars in a vehicle cause dead angles in the visual field of the driver and accordingly bring potential safety hazard to the driver.

Thus, the front pillars should be designed as thin as possible in order to minimize the impact thereof on the visual field of the driver. However, by taking the structural strength of the vehicle into consideration, the thickness of the pillars should be balanced. Moreover, even though the pillars are designed very thin, they still exist and cannot be removed. Thereby, how to resolve the view blocking problem caused by the pillars has become a major issue in today's vehicle design.

### SUMMARY OF THE INVENTION

Accordingly, the present invention is directed to an image display system, in which a display unit is disposed on a pillar inside a vehicle, an external image is captured through an image capturing unit, and an image blocked by the pillar is displayed in the display unit.

The present invention is directed to an image display method, in which a specific range image displayed in a display unit is determined according to the correspondence between a driver and a pillar.

The present invention provides an image display method adapted to an image display system. The image display system is deployed in a vehicle. In the image display method, an external image outside the vehicle is captured through a first image capturing unit. A specific range image is selected in the external image according to an adjusting signal. The specific range image is displayed in a display unit.

According to an embodiment of the present invention, the image display method further includes following steps. A driver image is captured through a second image capturing unit, and the driver image is analyzed to generate the adjusting signal.

According to an embodiment of the present invention, in the step of analyzing the driver image to generate the adjusting signal, a specific position is identified in the driver image, and a relative position information with respect to a pillar is obtained according to the specific position, so as to generate the adjusting signal. Additionally, in the step of analyzing the driver image, at least one of a gazing direction of an eyeball and a height of the eyeball to a datum plane in the driver image is further analyzed.

According to an embodiment of the present invention, a display range of the external image is larger than a display range of the display unit. Additionally, the first image capturing unit may be disposed outside the vehicle, and the second image capturing unit may be disposed inside the vehicle.

The present invention provides an image display system adapted to a vehicle. The image display system includes a first image capturing unit, a display unit, and an image processing unit. The first image capturing unit captures an external image outside the vehicle. The display unit is disposed on a pillar in the vehicle. The image processing unit is coupled to the first image capturing unit and the display unit. The image processing unit receives the external image from the first image capturing unit, selects a specific range image in the external image according to an adjusting signal, and displays the specific range image in the display unit.

According to an embodiment of the present invention, the image display system further includes a second image capturing unit coupled to the image processing unit. The second image capturing unit captures a driver image, and the image processing unit analyzes the driver image to generate the adjusting signal.

According to an embodiment of the present invention, the image processing unit identifies a specific position in the driver image and obtains a relative position information with respect to the pillar according to the specific position to generate the adjusting signal. Additionally, the image processing unit further analyzes at least one of a gazing direction of an eyeball and a height of the eyeball to a datum plane in the driver image.

According to an embodiment of the present invention, a display range of the external image captured by the first image capturing unit is larger than a display range of the display unit.

According to an embodiment of the present invention, the vehicle has a window, the pillar is disposed at one side of the window, a window image is obtained through a window by a driver, and the specific range image and the window image are connected into a continuous image.

According to an embodiment of the present invention, the specific range image is a visual field of the driver blocked by the pillar.

As described above, in the present invention, a display unit is disposed on a pillar inside a vehicle, an external image is captured through an image capturing unit, and an image blocked by the pillar is displayed in the display unit. Thus, a driver can see the scene blocked by the pillar clearly through the display unit, so that the view blocking problem caused by the pillar is resolved.

These and other exemplary embodiments, features, aspects, and advantages of the invention will be described and become more apparent from the detailed description of exemplary embodiments when read in conjunction with accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of an image display system according to a first embodiment of the present invention.

FIG. 2 is a flowchart of an image display method according to the first embodiment of the present invention.

FIG. 3 is a block diagram of an image display system according to a second embodiment of the present invention.

FIG. 4 is a diagram of an image display system deployed in a vehicle according to the second embodiment of the present invention.

FIG. 5 is a flowchart of an image display method according to the second embodiment of the present invention.

FIG. 6 is a diagram illustrating a display range and a plurality of display coordinate ranges of an external image according to the second embodiment of the present invention.

FIG. 7 is a diagram illustrating a plurality of visual field directions according to the second embodiment of the present invention.

FIG. 8 is a diagram illustrating the inside of a vehicle according to the second embodiment of the present invention.

FIGS. 9A-9C are diagrams illustrating images displayed in a display unit according to the second embodiment of the present invention.

FIG. 10 is a block diagram of an image display system according to a third embodiment of the present invention.

FIG. 11 is a diagram illustrating the inside of a vehicle according to the third embodiment of the present invention.

### DESCRIPTION OF THE EMBODIMENTS

The view blocking problem caused by the front pillars in a vehicle brings safety hazard to the driver. Thus, the present invention provides an image display method and an image display system to resolve the view blocking problem caused by the pillars. Reference will now be made in detail to embodiments of the present invention, examples of which are illustrated in the accompanying drawings. Wherever possible, the same reference numbers are used in the drawings and the description to refer to the same or like parts. However, the embodiments described above are only examples and are not intended to limit the scope of the present invention, and the characteristics mentioned in each embodiment or a combination thereof can be implemented without departing the scope and spirit of the present invention.

### First Embodiment

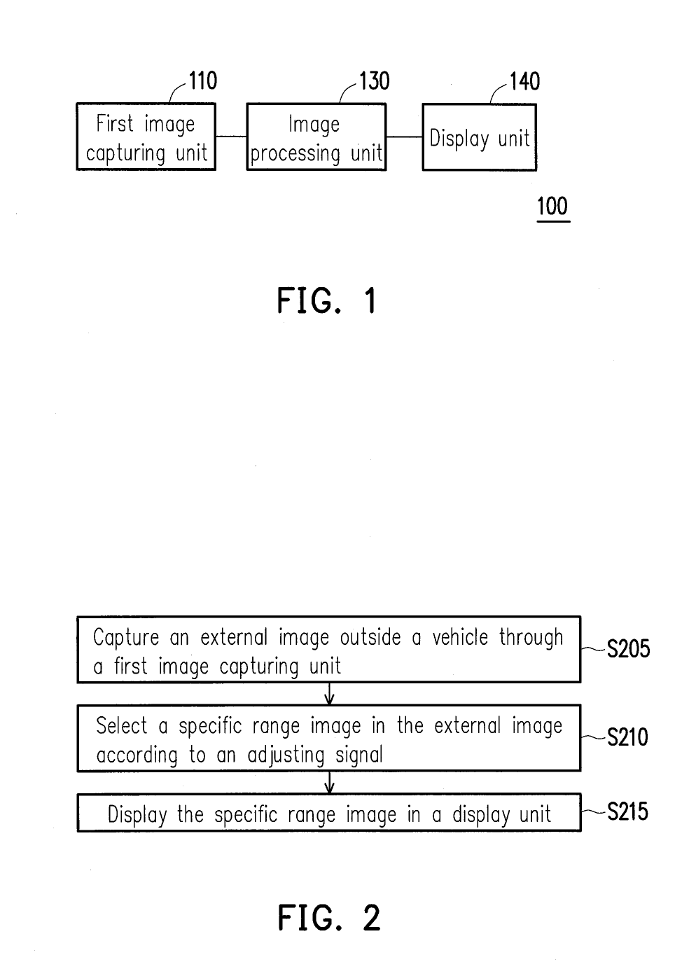

FIG. 1 is a block diagram of an image display system according to the first embodiment of the present invention. In the present embodiment, the image display system 100 is deployed in a vehicle for assisting the driving of the vehicle. Referring to FIG. 1, the image display system 100 includes a first image capturing unit 110, an image processing unit 130, and a display unit 140. The image processing unit 130 is respectively coupled to the first image capturing unit 110 and the display unit 140. The first image capturing unit 110 may be disposed outside the vehicle for capturing an external image outside the vehicle. The display unit 140 is disposed on a pillar inside the vehicle (for example, on a pillar between the windshield and the front-left door).

The first image capturing unit 110 may be a video camera or a camera with a charge coupled device (CCD) lens, a complementary metal oxide semiconductor transistor (CMOS) lens, or an infrared lens. However, the present invention is not limited thereto.

The display unit 140 may be a liquid-crystal display (LCD), a plasma display, a vacuum fluorescent display (VFD), a light-emitting diode (LED) display, a field emission display (FED), and/or any other suitable type of display. However, the type of the display unit 140 is not limited herein. In addition, the display range of the display unit 140 may be designed according to the size of the pillar.

The image processing unit 130 may be a hardware component (for example, a chipset or a processor), a software component (for example, an operating system or an application program), or a combination of hardware and software components with calculation and processing capabilities. The image processing unit 130 may be a central processing unit (CPU), a graphics processing unit (GPU), a programmable microprocessor, a digital signal processor (DSP), a programmable controller, an application specific integrated circuit (ASIC), a programmable logic device (PLD), or any other similar device.

Below, steps of the image display method will be described in detail with reference to the image display system 100.

FIG. 2 is a flowchart of an image display method according to the first embodiment of the present invention. Referring to both FIG. 1 and FIG. 2, in step S205, an external image outside a vehicle is captured through the first image capturing unit 110.

Then, in step S210, the image processing unit 130 selects a specific range image in the external image according to an adjusting signal. To be specific, the image processing unit 130 receives the external image from the first image capturing unit 110. Herein the display range of the external image is larger than the display range of the display unit 140. Thus, after the image processing unit 130 obtains the adjusting signal, the image processing unit 130 selects the specific range image in the external image according to the adjusting signal. Herein the display range of the specific range image matches the display range of the display unit 140.

The display range of the external image captured by the first image capturing unit 110 is larger than the display range of the display unit 140. The adjusting signal may be generated when a user manually select a specific range in the external image displayed in the display unit 140. For example, the user directly selects a specific range in the external image displayed in the display unit 140.

Next, in step S215, the image processing unit 130 displays the specific range image in the display unit 140. The specific range image may be the image in the external image blocked by the pillar (i.e., the visual field of the driver blocked by the pillar).

In the present embodiment, the vehicle has a window. The pillar for disposing the first image capturing unit 110 is disposed at one side of the window, and the driver sees a window image through the window. Besides, the specific range image and the window image are connected into a continuous image.

In addition, the adjusting signal may also be automatically instead of manually generated, which will be described below with reference to another embodiment.

### Second Embodiment

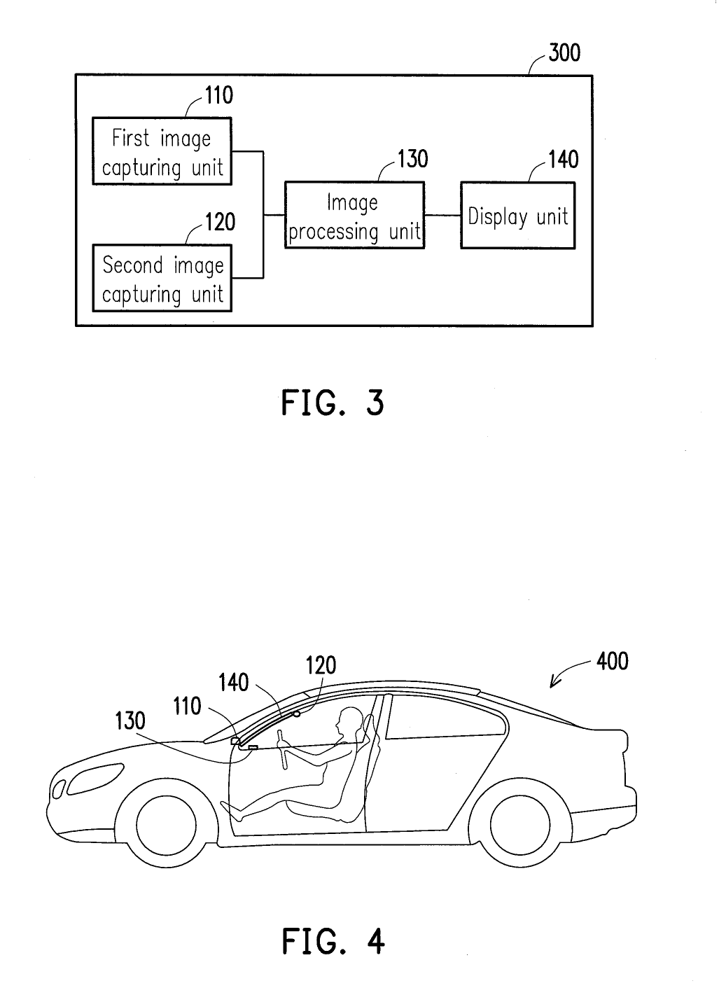

FIG. 3 is a block diagram of an image display system according to the second embodiment of the present invention. In the present embodiment, the image display system 300 is deployed in a vehicle for assisting the driving of the vehicle. Referring to FIG. 3, the image display system 300 includes a first image capturing unit 110, a second image capturing unit 120, an image processing unit 130, and a display unit 140. The image processing unit 130 is respectively coupled to the first image capturing unit 110, the second image capturing unit 120, and the display unit 140. The difference between the present embodiment and the first embodiment is that the image display system 300 further includes the second image capturing unit 120. Those components in the present embodiment having the same functions as those in the first embodiment will be referred to by using the same reference numerals and will not be described herein.

Similar to the first image capturing unit 110, the second image capturing unit 120 may be a video camera or a camera with a CCD lens, a CMOS lens, or an infrared lens. However, the present invention is not limited thereto. In the present embodiment, the first image capturing unit 110 is disposed outside the vehicle for capturing an external image outside the vehicle. The second image capturing unit 120 is disposed inside the vehicle, and the lens of the second image capturing unit 120 is faced towards the driver for capturing a driver image. However, the disposition of the first image capturing unit 110 and the second image capturing unit 120 described above is only an implementation pattern but intended to limit the scope of the present invention.

Unlike that in the first embodiment, besides receiving the external image from the first image capturing unit 110, the image processing unit 130 also receives the driver image from the second image capturing unit 120 and analyzes the driver image to generate an adjusting signal. After that, the image processing unit 130 selects a specific range image in the external image according to the adjusting signal and displays the specific range image in the display unit 140. Accordingly, the driver can see the external view blocked by the pillar through the display unit 140 disposed on the pillar.

FIG. 4 is a diagram of an image display system deployed in a vehicle according to the second embodiment of the present invention. Herein the image processing unit 130 may be an electronic device placed in the vehicle. For example, the image processing unit 130 can be implemented as a smart phone, a tablet PC, or a navigation device.

Referring to FIG. 4, the first image capturing unit 110 is disposed outside the vehicle 400, the second image capturing unit 120 is disposed inside the vehicle 400, and the display unit 140 is disposed on a pillar. Additionally, the image processing unit 130 is placed on a platform close to the driver's seat. The image processing unit 130 is coupled to the first image capturing unit 110, the second image capturing unit 120, and the display unit 140 in a wired or wireless manner. Besides, the image processing unit 130 may also be a component of the control system of the vehicle 400. For example, the image processing unit 130 can be an electronic chip in the control system of the vehicle 400. The implementation of the image processing unit 130 is not limited herein.

In other embodiments, the first image capturing unit 110 may also be disposed at any position inside the vehicle 400 where an external image can be clearly captured (i.e., the first image capturing unit 110 is not limited to being disposed inside the vehicle 400), and the second image capturing unit 120 may also be disposed at a position where a driver image can be clearly captured, such as below the pillar or above the rearview mirror.

Below, steps of the image display method will be described in detail with reference to the image display system 300.

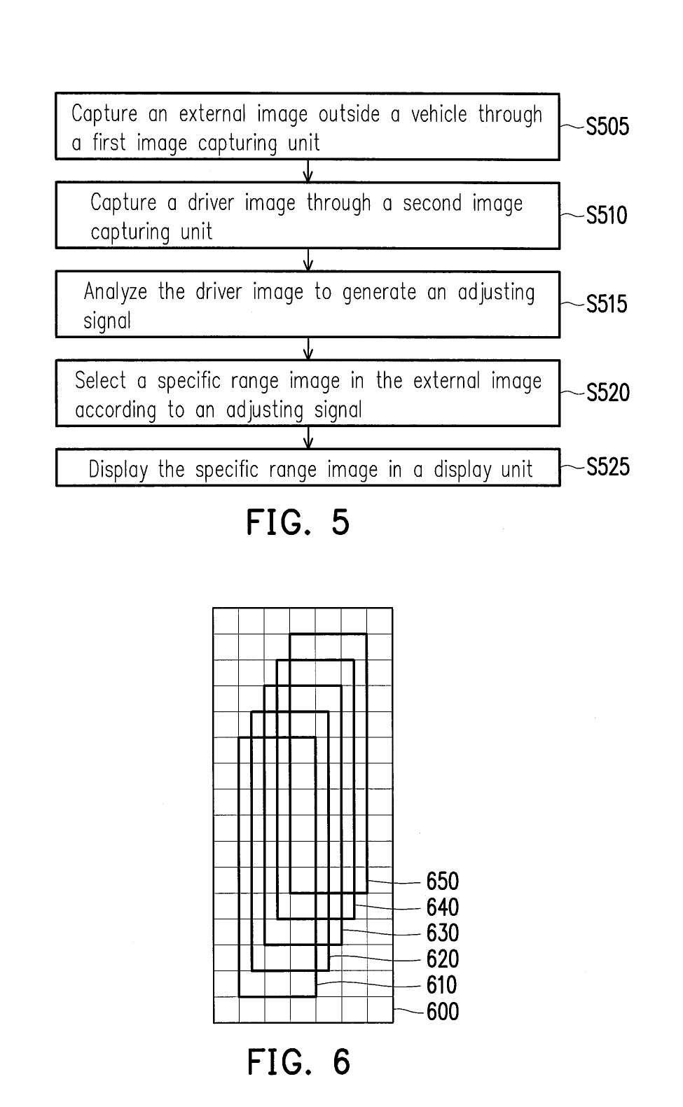

FIG. 5 is a flowchart of an image display method according to the second embodiment of the present invention. Referring to FIG. 3 to FIG. 5, in step S505, an external image outside the vehicle is captured through the first image capturing unit 110. In step S510, a driver image is captured through the second image capturing unit 120. The execution sequence of steps S505 and S510 is not limited herein. For example, step S505 is executed before step S510, step S510 is executed before step S505, or step S505 and step S510 are executed at the same time.

Next, in step S515, the image processing unit 130 analyzes the driver image to generate the adjusting signal. To be specific, the image processing unit 130 receives the driver image from the second image capturing unit 120, then analyzes the driver image to obtain the relative position information between the driver and the pillar, and generates the adjusting signal according to the relative position information. The adjusting signal determines the image to be displayed in the display unit 140.

After that, in step S520, the image processing unit 130 selects a specific range image in the external image according to the adjusting signal. To be specific, the image processing unit 130 receives the external image from the first image capturing unit 110. The display range of the external image is larger than the display range of the display unit 140. Thus, after the image processing unit 130 obtains the adjusting signal, the image processing unit 130 selects the specific range image in the external image according to the adjusting signal. Herein the display range of the specific range image matches the display range of the display unit 140.

Thereafter, in step S325, the image processing unit 130 displays the specific range image in the display unit 140. Namely, the image processing unit 130 obtains the relative position information between the driver and the pillar by analyzing the driver image, so as to determine the specific range image to be displayed in the display unit 140. The specific range image may be the part of the external image that is blocked by the pillar.

For example, the display range of the external image is preset, and a plurality of display coordinate ranges is configured in advance according to the display range of the display unit 140. Besides, a display coordinate range corresponding to each relative position information can be obtained one by one beforehand according to the relative position information between different drivers and the pillar. After the image processing unit 130 obtains the relative position information between the driver and pillar by analyzing the driver image, the image processing unit 130 can obtain the display coordinate range corresponding to the relative position information and then select the specific range image in the external image according to the display coordinate range.

For example, the image processing unit 130 identifies the position of an eyeball of the driver in the driver image and obtains the relative position information between the driver and the pillar according to the eyeball's position, so as to generate the adjusting signal. For example, after identifying the position of the eyeball of the driver, the image processing unit 130 obtains the relative position information of the driver's eyeball with respect to the pillar according to pre-corrected parameters (for example, the shooting angle, the disposed position of the second image capturing unit 120, and the focal length, etc) of the second image capturing unit 120 and coordinate information of the pillar. Moreover, the image processing unit 130 generates the adjusting signal according to the relative position information.

Additionally, the image processing unit 130 further obtains a gazing direction of the eyeball and/or a height of the eyeball to a datum plane according to the eyeball position. Aforementioned datum plane may be the shooting level of the second image capturing unit 120 or a platform in front of the driver's seat. Besides, the image processing unit 130 obtains the visual field direction when the eyeball looks into the direction of the pillar (i.e., an implementation of aforementioned relative position information) according to the position of the eyeball, the gazing direction of the eyeball, and the height of the eyeball. Moreover, the image processing unit 130 generates the adjusting signal according to the visual field direction.

Besides the position of the driver's eyeball, the image processing unit 130 may also generate the adjusting signal by identifying another specific position of the driver. Herein the specific position may be the position of a facial feature or the position of a special object (for example, glasses or necklace) worn by the driver.

Herein it is assumed that the display range of the external image and a plurality of display coordinate ranges have been stored in a storage unit (not shown) of the image display system 300 in advance and each display coordinate range has a corresponding relative position information or a corresponding visual field direction (or each display coordinate range is corresponding to the relative position information and the visual field direction simultaneously). After obtaining the relative position information or the visual field direction, the image processing unit 130 obtains the corresponding display coordinate range from the storage unit and then generates the corresponding adjusting signal to specify the corresponding display coordinate range.

FIG. 6 is a diagram illustrating a display range and a plurality of display coordinate ranges of an external image according to the second embodiment of the present invention. In FIG. 6, the display range 600 of the external image has 7 units in the direction of the axis X and 16 units in the direction of the axis Y. The number of pixels in each unit is not limited herein. In the present embodiment, it is assumed that there are 5 display coordinate ranges (i.e., the display coordinate ranges 610-650). Besides, it is assumed that the display range of the display unit 140 has 3 units in the direction of the axis X and 10 units in the direction of the axis Y. Accordingly, the display range of each one of the display coordinate ranges 610-650 has 3 units in the direction of the axis X and 10 units in the direction of the axis Y.

Additionally, in other embodiments, the display coordinate range 610 may be represented with X1Y1 (i.e., the coordinates (1, 1) of the display range 600 of the external image is the origin of the display coordinate range 610), and the display coordinate range 620 may be represented with X2Y2 (i.e., the coordinates (2, 2) of the display range 600 of the external image is the origin of the display coordinate range 610). Similarly, the display coordinate range 630 may be represented with X3Y3, the display coordinate range 640 may be represented with X4Y4, and the display coordinate range 650 may be represented with X5Y5. The origin coordinates of each display coordinate range mentioned above is only an example for the convenience of description but not corresponding to that illustrated in FIG. 6. Each of the display coordinate ranges 610-650 is corresponding to a visual field direction. Below, an example will be described.

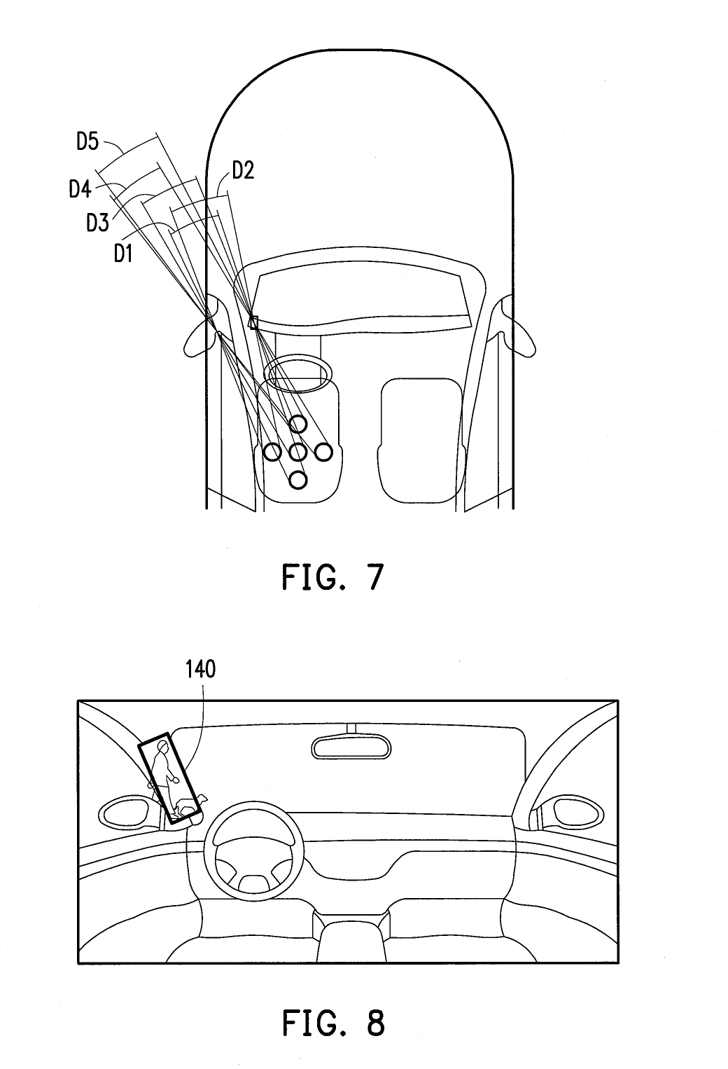

FIG. 7 is a diagram illustrating a plurality of visual field directions according to the second embodiment of the present invention. Referring to both FIG. 6 and FIG. 7, the visual field direction D1 is corresponding to the display coordinate range 650, the visual field direction D2 is corresponding to the display coordinate range 640, the visual field direction D3 is corresponding to the display coordinate range 630, the visual field direction D4 is corresponding to the display coordinate range 620, and the visual field direction D5 is corresponding to the display coordinate range 610. When the image processing unit 130 analyzes the driver image to obtain the relative position information (i.e., the visual field direction D2), the adjusting signal indicates the display coordinate range 640, so that the display coordinate range 640 is selected in the external image and displayed in the display unit 140.

In other embodiments, the adjusting signal may also be a masking signal such that the part outside the corresponding display coordinate range is masked according to the relative position information or the visual field direction.

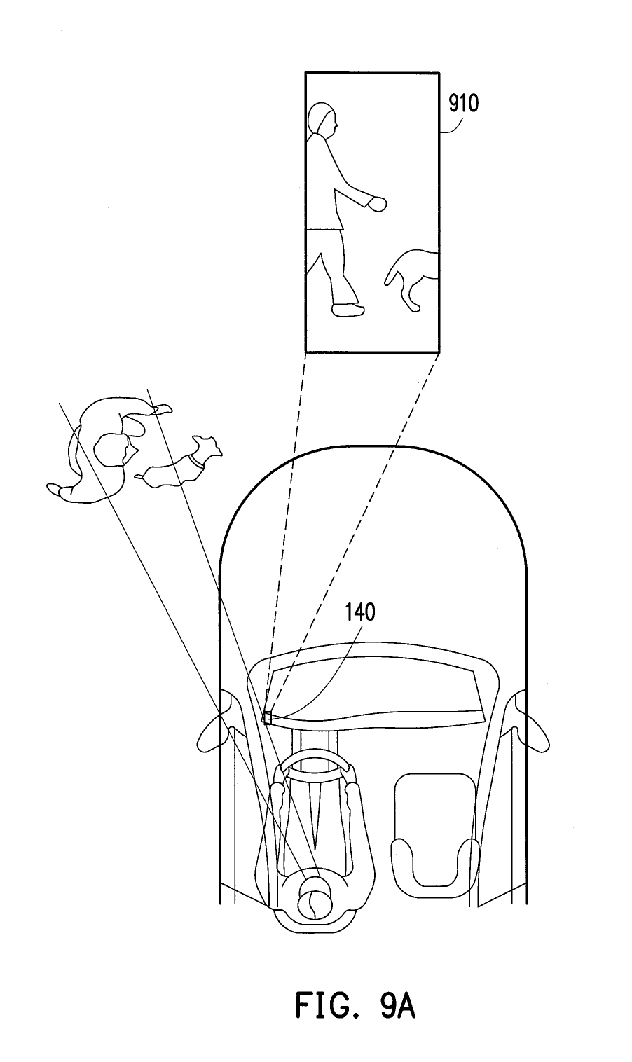

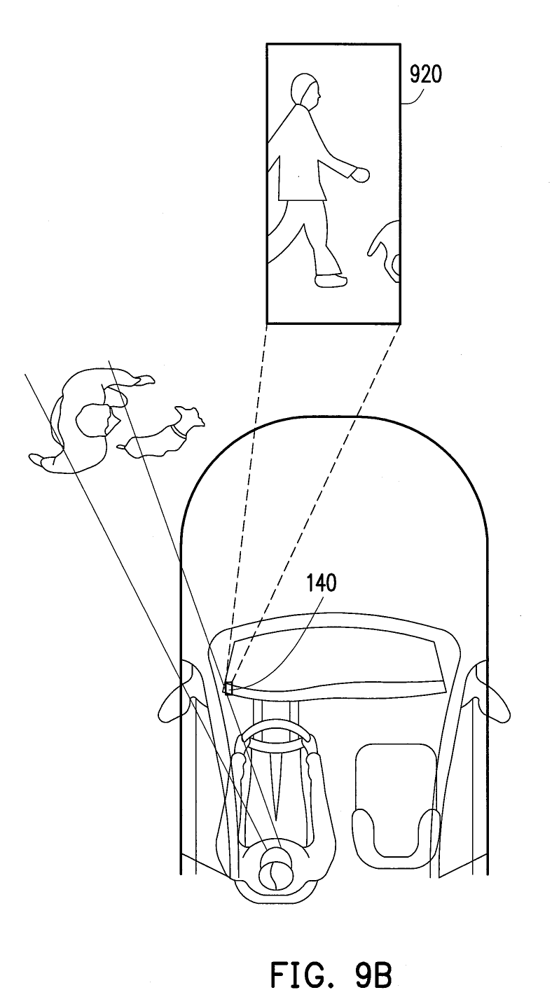

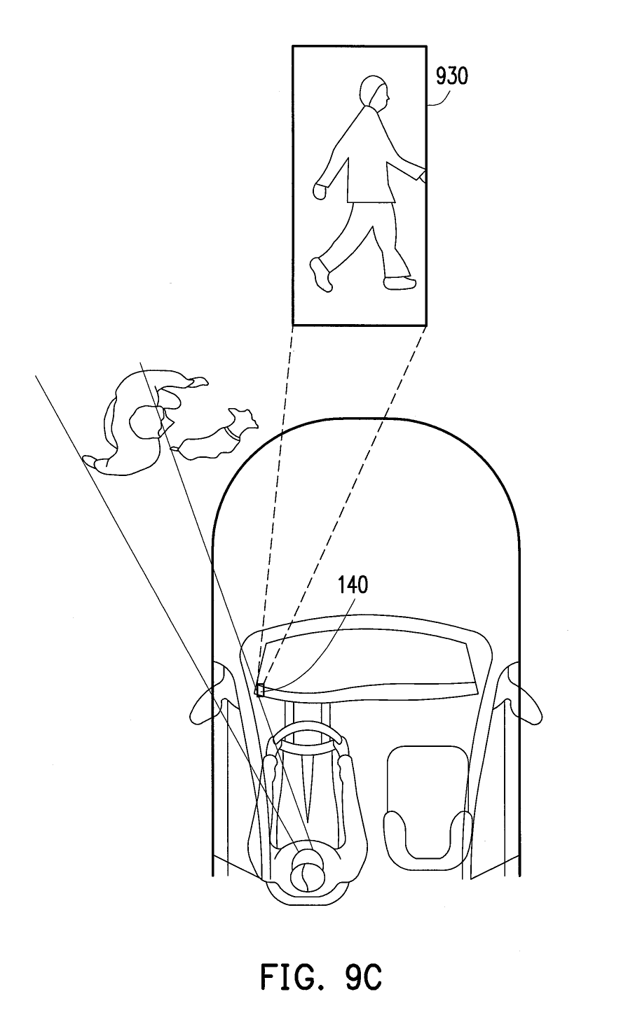

Below, the image displayed in the display unit 140 will be described with reference to another example. FIG. 8 is a diagram illustrating the inside of a vehicle according to the second embodiment of the present invention. FIGS. 9A-9C are diagrams illustrating images displayed in a display unit according to the second embodiment of the present invention. In the present embodiment, the display unit 140 is disposed on a pillar between the windshield and the front-left door. The display unit 140 can display the exact specific range image blocked by the pillar through the image display method described above.

In addition, when the driver adjusts his/her position and accordingly the visual field direction of the driver changes, the image displayed in the display unit 140 also changes. As shown in FIGS. 9A-9C, when the visual field direction moves from right to left, the specific range images 910-930 in the image displayed in the display unit 140 move from right to left accordingly. Namely, the visual field direction in FIG. 9B is further left than that in FIG. 9A, and accordingly the specific range image 920 in FIG. 9B is further left than the specific range image 910 in FIG. 9A. The visual field direction in FIG. 9C is further left than that in FIG. 9B, and accordingly the specific range image 930 in FIG. 9C is further left than the specific range image 920 in FIG. 9B.

### Third Embodiment

Display units and image capturing units may also be disposed on the pillars at both sides of the windshield, which will be described below with reference to another embodiment.

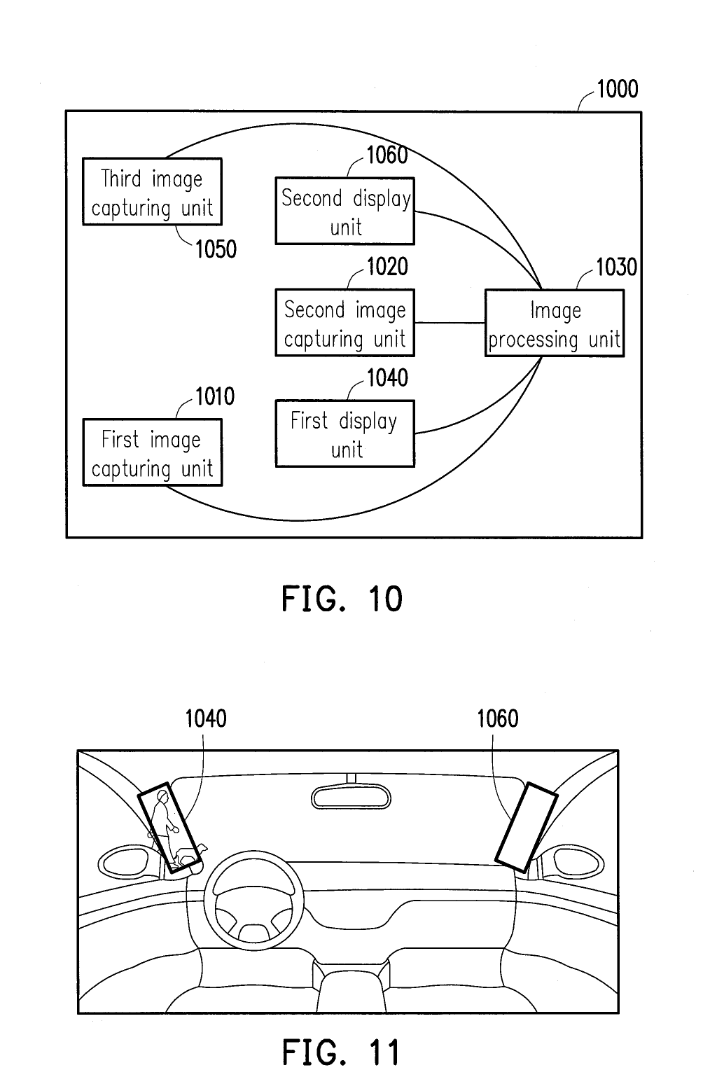

FIG. 10 is a block diagram of an image display system according to the third embodiment of the present invention. In the present embodiment, the image display system 1000 is deployed in a vehicle for assisting the driving of the vehicle. Referring to FIG. 10, the image display system 1000 includes a first image capturing unit 1010, a second image capturing unit 1020, an image processing unit 1030, a first display unit 1040, a third image capturing unit 1050, and a second display unit 1060. The image processing unit 1030 is respectively coupled to the first image capturing unit 1010, the second image capturing unit 1020, the first display unit 1040, the third image capturing unit 1050, and the second display unit 1060 in a wired or wireless manner.

The second image capturing unit 1020 is disposed inside the vehicle (for example, the lens of the second image capturing unit 1020 is faced towards the driver) for capturing a driver image. The function of the second image capturing unit 1020 is similar to that of the second image capturing unit 120 in the second embodiment and can be referred to related descriptions in the second embodiment.

The first image capturing unit 1010 captures an external image of a first side (for example, the left side) of the vehicle, and the third image capturing unit 1050 captures an external image of a second side (for example, the right side) of the vehicle. The first display unit 1040 is disposed on a pillar at the first side inside the vehicle (for example, the pillar between the windshield and the front-left door), and the second display unit 1060 is disposed on a pillar at the second side inside the vehicle (for example, the pillar between the windshield and the front-right door).

The functions of the first image capturing unit 1010 and the third image capturing unit 1050 are similar to that of the first image capturing unit 110 in the first embodiment and can be referred to related descriptions in the first embodiment.

The image processing unit 1030 receives the external image from the first image capturing unit 1010 and the driver image from the second image capturing unit 1020 and analyzes the driver image to generate an adjusting signal. After that, the image processing unit 1030 selects a specific range image in the external image according to the adjusting signal and displays the specific range image in the first display unit 1040. This image display method is similar to that in the second embodiment therefore can be referred to related descriptions of the second embodiment and FIG. 5 and will not be described herein.

Besides, the image processing unit 1030 receives the external image of the second side from the third image capturing unit 1050 and the driver image from the second image capturing unit 1020 and analyzes the driver image to generate an adjusting signal. After that, the image processing unit 1030 selects another specific range image in the external image captured by the third image capturing unit 1050 according to the adjusting signal and displays this specific range image in the second display unit 1060. This image display method is also similar to that in the second embodiment therefore can be referred to related descriptions of the second embodiment and FIG. 5 and will not be described herein.

Through the technique provided by the third embodiment, by disposing the first display unit 1040 and the second display unit 1060, the visual field of the driver in the vehicle is not blocked, as shown in FIG. 11. FIG. 11 is a diagram illustrating the inside of a vehicle according to the third embodiment of the present invention. Referring to FIG. 11, the first display unit 1040 is disposed on the pillar between the windshield and the front-left door, and the second display unit 1060 is disposed on the pillar between the windshield and the front-right door. Thus, the first display unit 1040 and the second display unit 1060 can display the specific range images blocked by the pillars exactly.

As described above, in foregoing embodiments, a display unit is disposed on a pillar inside a vehicle, an external image is captured through an image capturing unit, and an image blocked by the pillar is displayed in the display unit, so that the driver can clearly see the view blocked by the pillar through the display unit. Thus, the view blocking problem caused by the pillar is resolved. In addition, the specific range image displayed in the display unit is determined according to the correspondence between the driver and the pillar, so that the image displayed in the display unit can be exactly the view blocked by the pillar. Thus, the unblocked view won't be displayed in the display unit.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An image display method, for an image display system, wherein the image display system is deployed in a vehicle, the image display method comprising:
capturing an external image outside the vehicle through a first image capturing unit;
selecting a specific range image in the external image according to an adjusting signal; and
displaying the specific range image in a display unit, wherein the display unit is disposed on a pillar in the vehicle.

2. The image display method according to claim 1 further comprising:
capturing a driver image through a second image capturing unit; and
analyzing the driver image to generate the adjusting signal.

3. The image display method according to claim 2, wherein the step of analyzing the driver image to generate the adjusting signal comprises:
identifying a specific position in the driver image; and
obtaining a relative position information with respect to the pillar according to the specific position to generate the adjusting signal.

4. The image display method according to claim 3, wherein the step of analyzing the driver image further comprises:
analyzing at least one of a gazing direction of an eyeball and a height of the eyeball to a datum plane in the driver image.

5. The image display method according to claim 2, wherein the first image capturing unit is disposed outside the vehicle, and the second image capturing unit is disposed inside the vehicle.

6. The image display method according to claim 1, wherein a display range of the external image captured by the first image capturing unit is larger than a display range of the display unit.

7. An image display system, adapted to a vehicle, the image display system comprising:
a first image capturing unit, capturing an external image outside the vehicle;
a display unit, disposed on a pillar in the vehicle; and
an image processing unit, coupled to the first image capturing unit and the display unit, receiving the external image from the first image capturing unit, selecting a specific range image in the external image according to an adjusting signal, and displaying the specific range image in the display unit.

8. The image display system according to claim 7 further comprising:
a second image capturing unit, coupled to the image processing unit, wherein the second image capturing unit captures a driver image, and the image processing unit analyzes the driver image to generate the adjusting signal.

9. The image display system according to claim 8, wherein
the image processing unit identifies a specific position in the driver image and obtains a relative position information with respect to the pillar according to the specific position to generate the adjusting signal.

10. The image display system according to claim 9, wherein the image processing unit analyzes at least one of a gazing direction of an eyeball and a height of the eyeball to a datum plane in the driver image.

11. The image display system according to claim 7, wherein a display range of the external image captured by the first image capturing unit is larger than a display range of the display unit.

12. The image display system according to claim 7, wherein the vehicle has a window, the pillar disposed at one side of the window, a window image is obtained through the window by a driver, and the specific range image and the window image are connected into a continuous image.

13. The image display system according to claim 7, wherein the specific range image is a visual field of the driver blocked by the pillar.
